(19) United States
(12) Patent Application Publication
(10) Pub. No.: US 2013/0089846 A1
(43) Pub. Date: Apr. 11, 2013

(54) SYSTEMS, METHODS, AND PRODUCTS ADAPTED TO PROVIDE PHYSICAL THERAPY

(71) Applicant: LOEV REINEKE LLC, Potomac, MD (US)

(72) Inventors: Marc Loev, Potomac, MD (US); Sean Reineke, Potomac, MD (US)

(73) Assignee: LOEV REINEKE LLC, Potomac, MD (US)

(21) Appl. No.: 13/685,044

(22) Filed: Nov. 26, 2012

Related U.S. Application Data
(63) Continuation-in-part of application No. PCT/US2012/030842, filed on Mar. 28, 2012.
(60) Provisional application No. 61/468,923, filed on Mar. 29, 2011.

(51) Int. Cl. G09B 19/00

(52) U.S. Cl. CPC G09B 19/00
USPC 434/262

(57) ABSTRACT

A process and computer program product involving a computer readable medium tangibly recording computer program logic to provide a physical therapy resource electronically to a patient remote from a physical therapy clinic, hospital, or the like. The computer program product includes code to present instructions for physical activity to the patient via a display, code to receive data from a user interface device, the data indicating movement of the patient, code to analyze the data from the user interface device to discern achievement within a physical therapy regimen, and code to select one or more subsequent exercises for the patient based at least in part on the analyzed data. Systems and related physical therapy products are also disclosed.

### CROSS-REFERENCE TO RELATED APPLICATIONS

This application is a continuation of PCT/US2012/030842, filed Mar. 28, 2012, now pending, which claims the benefit of U.S. Provisional Application No. 61/468,923, filed Mar. 29, 2011, now expired. The entire content of each of the foregoing applications is hereby incorporated herein in its entirety by express reference thereto.

### TECHNICAL FIELD

The invention relates to a video series and interactive, electronic-media-based physical therapy (including functional restoration) instruction system adapted to provide physical therapy to a patient in their home or other location of their choice (in contrast to being at a physical therapy clinic or outpatient clinic where physical therapy is typically provided). The invention encompasses processes to recommend and/or utilize remotely-based, private location, physical therapy instruction for a physical functional limitation of the patient that permits or directs the patient to access a physical therapy resource by electronic media.

### BACKGROUND

It is estimated that there are 60 million Americans who presently lack a credible, convenient, and low-cost option for treating their “pain and functional limitations” in a sustainable fashion even with medical guidance to do so.

The majority of these underserved Americans fall into two broad categories. The first is the individual with mild aches and pains who is presently unable to participate, or is fearful of participating, in typical well-known mainstream fitness programs. The second category includes the individual for which a mild exercise and fitness program has been recommended or prescribed by their healthcare provider as a means to decrease their mild pain and to improve their function. These individuals are currently spending over $100 B/year on remedies in the hopes of obtaining relief, including over-the-counter and prescription medications, topical creams and gels, chiropractic visits, doctors visits, physical therapy, gym memberships, exercise devices, hot and cold packs, support braces, injections, and surgery. Presently, healthcare providers including, but not limited to, chiropractors, physical therapists, physicians, nurse practitioners, and physician assistants have limited therapeutic exercise recommendations other than physical therapy, fitness programs, or gym memberships for these patients.

### SUMMARY OF THE DISCLOSURE

The inventors have developed alternatives to the presently available options as a way of increasing patient compliance, diminishing healthcare cost, improving patient outcomes, and minimizing recidivism. Noncompliance, including a patient's failure to engage in or complete physical therapy often perpetuates chronic or recurrent pain causing patients to repeatedly seek medical care. This perpetuation is a significant problem for patients, the medical community, commercial insurers and federal health care programs too. Further, typical DVD exercise and fitness programs are not tailored to the needs of people with pain, nor do they cater to specific therapeutic objectives.

Various embodiments include systems, methods, and video and computer program products to provide patients with at-home or other private-location physical therapy instruction (e.g., in a hotel, at sea, etc.), preferably delivered in electronic-media-based form at a location other than a conventional physical therapy clinic or outpatient clinic where physical therapy is typically provided. “Electronic-media” is meant herein to include digital information or other electronic content, even if stored or encoded in physical objects, such as a DVD, computer hard drive, flash drive, and the like. One example includes a method whereby a health care provider recommends or prescribes a physical therapy regimen that is accessed in electronic-media-based form for use in the home. “In the home,” “in-home,” or “at home” are meant to include a person's home as well as any other location remote from a physical therapy clinic, hospital, outpatient clinic, or doctor's office, such as a guest room at a hotel or a third party's house; a cabin or other space on a ship, boat, or submarine; a semi-trailer, RV, truck, or other automotive vehicle with sufficient space and electricity; a tent or portable shelter with sufficient utilities for operation of electronic media; and the like. In one example, the instruction is not provided by a physical therapy clinic, outpatient clinic or hospital, though it is within the scope of embodiments for a physical therapy clinic, outpatient, or hospital to provide the instruction. The healthcare provider can sell a video or computer disc directly to a patient, sell web-based access directly to the patient, or have the patient buy a disc or web access from a third party. The third party includes, by way of non-limiting examples, a pharmacy, insurance company, health clubs, gyms, on-line retailer, and the like. The physical therapy regimen is preferably sold in discrete units directed to the functional physical therapy required to treat or manage pain in specific body parts, regions, or specific ailments. The instructional content for the therapeutic regimen may be accessed by DVD/Blu-ray player, video game console (e.g., Wii™ or X-box™), a computer, smartphone app, digital TV app, streaming electronic signal or the like.

As used herein “physical therapy” includes traditional physical therapy, which is typically prescribed to treat a diagnosed physical functional limitation and preferably also or alternatively has functional restoration and/or pain relief as a goal. Traditional physical therapy is usually supervised by a professional, typically at a traditional physical therapy site such as an outpatient clinic. Physical therapy, as used herein, also includes functional restoration treatment for any perceived functional limitation, whether or not diagnosed and whether or not treatment is prescribed or supervised by a healthcare professional. The physical therapy resources described herein include products, regimes, instructions, and electronic media.

Another example includes an interactive, electronic-media-based physical therapy instruction system. Such a system can be arranged from hardware including but not limited to a computer that accesses information from a disc or over a network, a smartphone that has a physical therapy instruction application, and a video game console that reads a disc or is connected to a network, or any combination thereof. The system of this embodiment can provide an interactive user interface that provides physical therapy instruction as multimedia content. The system is adapted to provide feedback to the patient during therapeutic sessions and may also monitor/track progress. Particular exercises can preferably be selected from a library of exercises based upon a user's progress, either through direct user input or measured patient feedback. One example embodiment uses motion gaming (e.g., Wii™ or X-box Kinect™) as an intelligent vehicle to deliver instructions and provide such real-time feedback.

In another example, a computer program product having a computer readable medium tangibly recording computer program logic for providing physical therapy instruction to a patient electronically at home is provided. The computer program product includes code to present instructions for physical activity to a patient via a display, where the physical activity includes an exercise that is indicated for treatment of a physical limitation. The computer program product also includes code to receive data from a user interface device, the data indicating movement of the patient, code to analyze the data from the user interface device to discern achievement within a physical therapy regimen, and code to select subsequent exercise(s) for the patient based at least in part on the analyzed data.

According to one embodiment, a process for providing a physical therapy resource to a patient in which the patient is remote from a physical therapy clinic, the process including recommending physical therapy for at least one of pain relief and a physical functional limitation of the patient; and directing the patient to access the physical therapy resource by electronic media.

According to another embodiment, a computer system for providing a physical therapy resource to a patient at home, the computer system including: a memory storing computer-executable code for providing physical therapy instruction to the patient to treat a physical function limitation, a processor in communication with the memory and executing the computer-executable code for providing the physical therapy instruction to the patient, a user interface system providing the physical therapy instruction to the patient as multi-media output and using feedback to measure user participation and progress in treating the physical function limitation.

According to yet another embodiment, a computer program product having a computer readable medium tangibly recording computer program logic for providing physical therapy to a patient electronically at home, the computer program product including: code adapted to present instructions for physical activity to the patient via a display, where the physical activity includes an exercise that is indicated for treatment of a physical limitation, code adapted to receive data from a user interface device, the data indicating movement of the patient, code adapted to analyze the data from the user interface device to discern achievement within a physical therapy regimen, and code adapted to select one or more subsequent exercises for the patient based at least in part on the analyzed data. It should be understood that various combinations of these embodiments are envisioned.

The foregoing has outlined rather broadly the features and technical advantages of the present invention in order that the description of the invention that follows may be better understood. Additional features and advantages of the invention will be described hereinafter which form the subject of the claims of the invention. It should be appreciated by those of ordinary skill in the art that the conception and specific embodiment disclosed may be readily utilized as a basis for modifying or designing other structures for carrying out the same purposes of the present invention. It should also be realized by those of ordinary skill in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures.

### BRIEF DESCRIPTION OF THE DRAWINGS

The present disclosure is best understood from the following detailed description when read with the accompanying figures. It is emphasized that various features are not drawn to scale. In fact, the dimensions of the various features may be arbitrarily increased or reduced for clarity of discussion. It is to be expressly understood that each of the figures is provided for the purpose of illustration and description only and is not intended as a definition of the limits of the present invention.

FIG. 1 illustrates a preferred embodiment of an exemplary flow of the process of the present invention;

FIG. 2 illustrates a preferred embodiment of a second exemplary flow of the process of the present invention;

FIG. 3 illustrates a preferred embodiment of a third exemplary flow of the process of the present invention;

FIG. 4 illustrates a preferred embodiment of an exemplary computer system of the present invention; and

FIG. 5 illustrates a preferred embodiment of an exemplary flow of workout routine options according to the present invention.

### DETAILED DESCRIPTION OF PREFERRED EMBODIMENTS

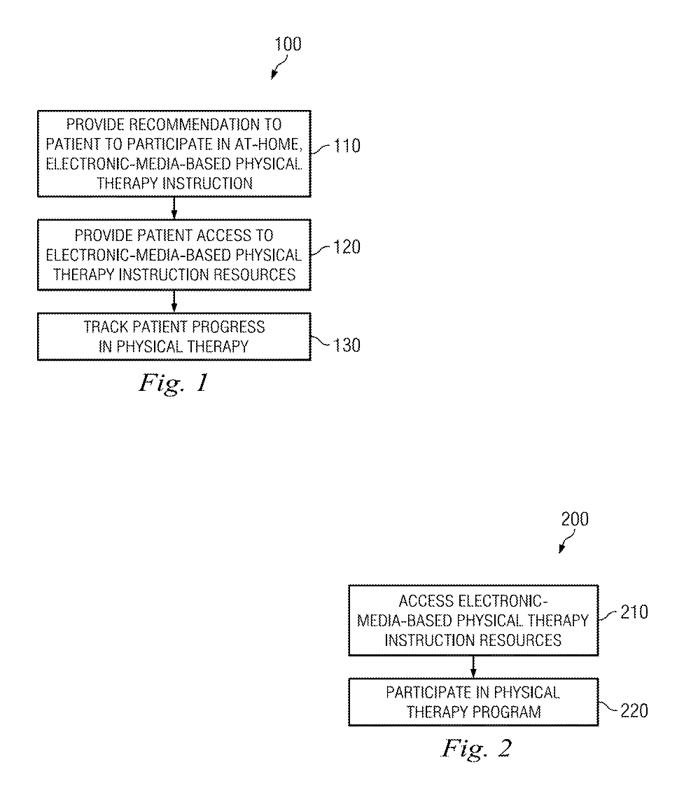

FIG. 1 is an illustration of exemplary flow 100, adapted according to one embodiment. Exemplary flow 100 may be performed entirely by a health care provider, though one or more actions may be performed by other entities, as explained further below.

In block 110, a recommendation is provided to a patient to participate in an at-home electronically-provided physical therapy regime. For instance, a physician may recommend, refer, dispense, sell, give, or prescribe an at-home electronically-provided physical therapy instruction program to the patient in response to a diagnosis of a physical limitation (e.g., back or shoulder pain, foot or leg sprain or pain, work injury, etc.). In another example, an employer may recommend, give sell, or provide an at-home electronically-provided physical therapy instruction program to the employee, or the patient may be referred by a physician to a physical therapist who then provides, sells, dispenses, gives, or utilizes an at-home electronically-provided physical therapy program as part of a proposed therapeutic regimen.

In the present embodiment, the recommended physical therapy program is not the conventional out-patient or in-patient physical therapy regimen that is typically performed at a facility. Instead, the present embodiment includes a regimen that can be completed remotely from conventional in- or out-patient therapy at home by the patient using standard home technology, such as a television, DVD player, Blu-ray player, gaming console, or computer, or combination thereof. It is an advantage of some embodiments that some patients may feel more comfortable at home and more appreciative of the lower-cost and substantial time-savings of the home option, thereby inviting at least a subset of patients to get involved and stay involved with the regimen. This can advantageously reduce recidivism, recurring or chronic pain, etc. through at least increased compliance, or even completion, of recommended physical therapy.

In block 120, the patient is provided access to the electronic-media-based physical therapy instruction resources. In one example, the physician may sell access in his or her office by dispensing or providing a disc to the patient or signing the patient up for on-line services. In another example, the physician may give the patient a prescription (or “script”) for the physical therapy program, and the patient then goes to a third party, such as a pharmacy, a company store at an employer, a retail store, or an on-line retailer, to get access to the electronic-media-based physical therapy instruction resource(s).

Block 120 may include being reimbursed for the electronic-media-based physical therapy instruction resources. For instance, the physician or third party may receive payment for providing access to the resources. In some instances, insurance may cover all or a part of the patient's access to the resources, e.g., there may be a small or no co-pay as a financial incentive by the insurance company to encourage patients to comply with a healthcare-professional-recommended physical therapy regimen.

In block 130, a health-care provider may track the patient's progress in the physical therapy regimen. In one example, the patient's participatory information may be available electronically and/or inferable from a subsequent physical exam, such as increased time between visits, fewer visits for pain management, decreased analgesic medication usage, or actual improvement in the condition being treated or managed.

FIG. 2 is an illustration of exemplary flow 200, adapted according to one embodiment. Flow 200 is from the perspective of a patient. In block 210, the patient accesses the electronic-media-based physical therapy regimen instruction resources. Block 210 may include using any of a variety of household technology to execute computer-readable data and provide a user interface with instructions for exercises.

In one example, the patient inserts an optical disc into a Digital Video Disc (DVD) player or Blu-ray player, and the physical therapy regimen instructions are displayed on a television, projected, or on a computer monitor similarly to a movie. In another example, the patient inserts a computer-readable medium into a computer, and the computer provides interactive instructions to the patient. In yet another embodiment, the patient inserts a disc or other medium into a gaming console (e.g., Wii™ or X-box™), and the gaming console provides interactive physical therapy instructions through its typical input components, such as a camera and motion sensors, a device including one or more accelerometers, or any combination thereof, and, for example, a connected television. In any embodiment, it is possible to provide some or all of the computer-readable code via a network rather than by a disc or other physical medium. In fact, some embodiments include access through a smartphone, television, or other device with specialized network applications (“apps”). Various embodiments are not limited by any particular technique for accessing the electronic-media-based resources.

In block 220, the patient participates in the physical therapy program. In one example, the patient adheres to a suggested regimen that lasts, e.g., around six to eight weeks and includes exercises to focus on particular physical limitations. The physical therapy program may be interactive, with intelligent, real-time feedback, or may be non-interactive with the patient keeping track of his or her own progress. In certain embodiments, the physical therapy program can increase in difficulty over time, or be based on real-time feedback or patient-selected increases in difficulty.

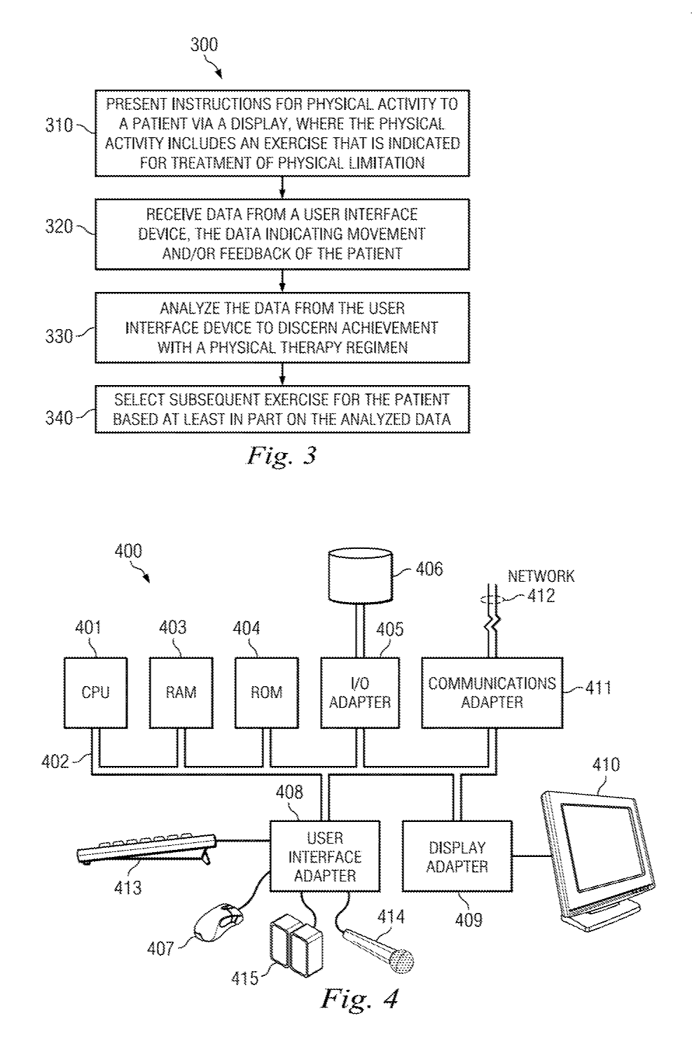

FIG. 3 is an illustration of exemplary flow 300, adapted according to one embodiment. Flow 300 shows the actions taken by some interactive embodiments, though it is understood that other embodiments may not be interactive.

In block 310, instructions for the physical therapy regimen are presented to the user via a display. The physical therapy regimen includes exercises that are indicated for treatment of physical limitation. The instructions may be presented to the user as an audio and video experience, though the scope of embodiments is not limited to a particular type, or combination of types, of media. Examples of instructions include a human image or computer graphic avatar performing exercises and encouraging the patient to complete the exercises by following the image or avatar. Furthermore, some embodiments include an avatar of the patient to encourage the patient, illustrate exercises, and/or guide the patient through the program. This user avatar may be alternatively or additionally to an avatar instructor. In some embodiments, other sensory inputs, such as tactile inputs via a handheld controller, may be provided to the user as well.

In block 320, data is received from a user interface device that indicates physical movements and/or feedback of the patient. In one example, the patient holds a motion-sensing controller and/or stands on a weight/balance sensing device. In another example, the patient stands in front of a camera that monitors the patient's motion. In a third example, the patient responds to an inquiry from the program through the use of a keyboard, controller or by speaking. In all three examples, the interface hardware sends signals to a computer processor that are indicative of the patient's motion and/or feedback. Various embodiments are not limited by any particular interface hardware, as other interface hardware now known or later developed may be adapted for use in association with some embodiments.

In block 330, the data from the user interface device is analyzed to discern patient achievement within the physical therapy regimen. For instance, the computer processor analyzes the data in real time to determine whether the user is at least approximating the movements of the exercise or whether the user is having difficulty with the exercise based upon the user's feedback. The computer processor may also generate cumulative scores and health data as the patient participates over time.

In block 340, subsequent exercises are selected for the patient based at least in part on the analyzed data. For instance, the patient's approximation of the movements of the exercise can be an indication as to whether more repetitions of the exercise are appropriate or whether the patient needs more instruction on performing the exercise or more exercises at that level to be better prepared for handling increased repetitions or complexity of exercise. Also, a patient's performance and/or their feedback in one exercise may be used to determine whether the patient should move on to a different exercise and which different exercises are appropriate. Blocks 310-340 illustrate a feedback loop where the patient receives instructions, performs movements in response to the instructions, and subsequent instructions are affected by the patient's performance and/or feedback in this embodiment. There is also an electronic feedback loop where the user interface devices provide patient movement data to the computer processor, which instructs the patient to move and cause the user interface devices to generate further data.

When implemented via computer-executable instructions, various elements of embodiments are in essence the software code defining the operations of such various elements. The executable instructions or software code may be obtained from a tangible readable medium (e.g., a hard drive media, optical media, RAM, EPROM, EEPROM, tape media, cartridge media, flash memory, ROM, memory stick, network storage device, and/or the like). In fact, readable media can include any medium that can store information.

FIG. 4 illustrates an example computer system 400 adapted according to one embodiment. That is, computer system 400 comprises an example system on which embodiments may be implemented (such as a computer, a smartphone, or a gaming console). Central processing unit (CPU) 401 is coupled to system bus 402. CPU 401 may be any general purpose or specialized purpose CPU. However, the present invention is not restricted by the architecture of CPU 401 as long as CPU 401 supports the inventive operations as described herein. CPU 401 may execute the various logical instructions according to embodiments. For example, one or more CPUs, such as CPU 401, may execute machine-level instructions according to the exemplary operational flow described above in conjunction with FIG. 3.

Computer system 400 also preferably includes random access memory (RAM) 403, which may be SRAM, DRAM, SDRAM, or the like. In this example, computer system 400 uses RAM 403 to store data and instructions as it executes code to perform actions illustrated in FIG. 3. Computer system 400 preferably includes read-only memory (ROM) 404 which may be PROM, EPROM, EEPROM, or the like. RAM 403 and ROM 404 hold user and system data and programs, as is well known in the art.

Computer system 400 also preferably includes input/output (I/O) adapter 405, communications adapter 411, user interface adapter 408, and display adapter 409. I/O adapter 405, user interface adapter 408, and/or communications adapter 411 may, in certain embodiments, enable a user to interact with computer system 400 in order to input information, such as selecting a particular exercise. I/O adapter 405, user interface adapter 408, and/or communications adapter 411 may also receive data on the user's movements and feedback to prompts and provide that data to CPU 401.

I/O adapter 405 preferably connects to storage device(s) 406, such as one or more of hard drive, compact disc (CD) drive, floppy disk drive, tape drive, etc. to computer system 400. The storage devices may be utilized when RAM 403 is insufficient for the memory requirements associated with storing multi-media data. Communications adapter 411 is preferably adapted to couple computer system 400 to network 412 (e.g., the Internet, a LAN, a cellular network, etc.) to, e.g., receive computer-readable code that embodies all or a portion of a physical therapy instruction computer program. User interface adapter 408 couples user input devices, such as keyboard 413, pointing device 407, and microphone 414 and/or output devices, such as speaker(s) 415 to computer system 400. Display adapter 409 is driven by CPU 401 to control the display on display device 410 to, for example, display a human user or avatar during physical therapy.

While FIG. 4 shows a general-purpose computer, it should be noted that the exact configuration of a portion of a system according to various embodiments may be somewhat different. For example, the same basic architecture is adapted into smaller or more specialized forms for gaming consoles and smartphones. In the cases of gaming consoles and smartphones, the user interface devices may include motion sensing controllers, touch screens, and/or the like.

Moreover, embodiments may be implemented on application specific integrated circuits (ASICs) or very large scale integrated (VLSI) circuits. In fact, persons of ordinary skill in the art may utilize any number of suitable structures capable of executing logical operations according to various embodiments.

Patients can access electronic-media-based physical therapy instruction resources through any market channel, including the following four examples. First, national and regional Healthcare Insurance Companies (HICs) are aggressively seeking to cut the utilization expenses of their millions of covered lives through preventative measures and less costly therapeutic options. Present high cost expenditures include but are not limited to healthcare provider visits, emergency room visits, physical therapy, medications, injections, other pain management services, and surgery. Partners/Distributors such as Kaiser Permanente, Blue Cross/Blue Shield, Aetna, and other commercial insurers, as well as governmental programs such as Medicare and Medicaid are interested in broadly disseminating a comparatively lower cost therapeutic program throughout their insurance networks. In some embodiments, HICs provide access to electronic-media-based physical therapy instruction resources by, e.g., providing, as covered a benefit, a disc to a patient, providing web access to the resources, and/or the like.

Second, Healthcare Providers (HCPs) are another market channel through which patients may access resources. There are thousands of HCPs who are experiencing diminishing annual income, e.g., due to recent healthcare payment changes. Many HCPs are presently seeking additional sources of income in their practices and would utilize a product that provides additional income to them while providing accessible and affordable treatment options to their patients. Examples of HCPs include, but are not limited to, Physicians, Physician specialties of Primary care, Orthopedics, Occupational Medicine, Physiatrists, Neurosurgeons, Pain Management Specialists, Neurologists, and Rheumatologists, as well as Chiropractors, Nurses and Nurse Practitioners, Physical Therapists, and the like. In one example, a HCP sells, dispenses, or gives a disc directly to a patient, or instructs the patient to go to a third party (or provides a prescription to be filled by a third party), such as a pharmacy, drug store, retail establishment, or website to receive the electronic-media-based physical therapy instruction resources. In some scenarios, HCPs may receive a profit from sales or distribution of the electronic-media-based physical therapy instruction resources.

Third, Large organizations are yet another marketing channel encompassed by the present disclosure. Governmental organizations and large corporate employers responsible for servicing vast numbers of individuals typically have a need to provide lower-cost but effective health care options. In fact, many large employers often seek low-cost options for employee injury treatment. In some examples, a large organization may give a disc directly to a patient or employee, recommend this disc be dispensed by their contracted or employed healthcare practitioners, or instruct the patient to go to a third party, such as a pharmacy, drug store, retail establishment, or website to receive the electronic-media-based physical therapy instruction resources. In some scenarios, organizations may receive volume discounts for large orders of the electronic-media-based physical therapy instruction resources.

Fourth, many individuals will be interested in obtaining the program outside of the aforementioned channels and may self-direct purchase of the product for themselves, relatives, friends or others. If they are unable or unwilling to gain access through the aforementioned channels, they will have the option of buying electronic-media-based physical therapy instruction resources directly through a number of channels, including, but not limited to, websites (e.g., by mail order, streaming, etc.), pharmacies (e.g., by DVD, audiovisual CD for computer, etc.), drug stores, retail establishments, health care providers (e.g., doctor's office, testing/diagnostic lab, etc.), health clubs, gyms, and infomercials.

The electronic-media-based physical therapy instruction resources can be offered in any number of forms. In one example, resources are sold in discrete units (e.g., discs, downloadable files) that are targeted at single, specific body areas. Examples of resources that focus on single areas are back, hip, shoulder, knee, neck, wrist, foot, ankle, joints and muscles, and areas affected by fibromyalgia. In some instances, the resources include a core component of generalized and comprehensive exercises of importance that are central to sustainable health and fitness.

A physical therapy regimen provided by electronic-media-based physical therapy instruction resources may include one or more of the following features. The scope of embodiments is not so limited, as any number of features for treatment of physical limitations may be included.

In one example, a regimen is a 4 to 12 week, optionally a 6-8 week, program that is similar to a course of traditional physical therapy, with the option for the individual to progress as they are able and with elements for maintenance. However, any length is possible for a given program depending on the physical therapy needed to manage or treat the condition, optionally but preferably as monitored by a subsequent visit to a healthcare provider if relevant.

Some programs include a module for “Assessment of Capabilities” and appropriateness of participation. Examples include questionnaires, real-time performance analysis, feedback, or combinations thereof that estimate a patient's capabilities. Such module may also query to determine specific reasons for participation and goals for each patient. Furthermore, the module may also include a Body Mass Index (BMI) assessment or other general health measures and goals for a patient to explore if desired. If the assessment identifies the need for weight loss, then separate promotional information, products and resources can be offered as part of the program. This may be particularly the situation for embodiments where the physical therapy regimen is focused on upper back, lower back, foot, ankle, knee, leg, neck, or hip-related pain. Interactions preferably include a high degree of positive reinforcement and encouragement to prolong participation and enhance effectiveness.

Various embodiments may also include interval assessment of progress and achievement of goals that can be accessed by the patient and/or other entities, such as HCPs, insurance companies, and large organizations. For instance, some embodiments include an option to track progress online so the data analysis can be utilized for further enhancement, marketing and sales, determination of credibility, corporate utilization, and insurance coverage benefits.

There are a wide variety of physical therapy exercise programs that can be constructed based upon a set of possible exercises. In one example, the programs include a core or fundamental exercise program, which encompasses the total body to provide stretching, strengthening, conditioning, and maintenance with the following emphases: yoga, tai chi, stretch, mild cardio exercise, and preferably combinations thereof. And in another example, there is provided specific body area exercise resources, such as regimens directed to lower backs, knees, shoulders, hips, wrists, necks, foot and ankle, musculoskeletal and joint, and fibromyalgia among others. Any given program may be tailored to functional restoration through flexibility enhancement, strength enhancement, fitness enhancement, and weight loss.

Exercises can be loosely categorized by type. Examples of types include, e.g., warm-up/cool-down, stretching, rehabilitative, flexibility (e.g., Pilates), movement (e.g., Yoga, Tai Chi), strength (e.g., upper body, lower body, core, etc.), toning, and cardio fitness. There is cross-over of exercises into types, and most exercises can have differing degrees (levels) of difficulty. Some exercises are preferably performed independently on both sides of the body, or optionally one side depending on the condition or body part(s) being addressed.

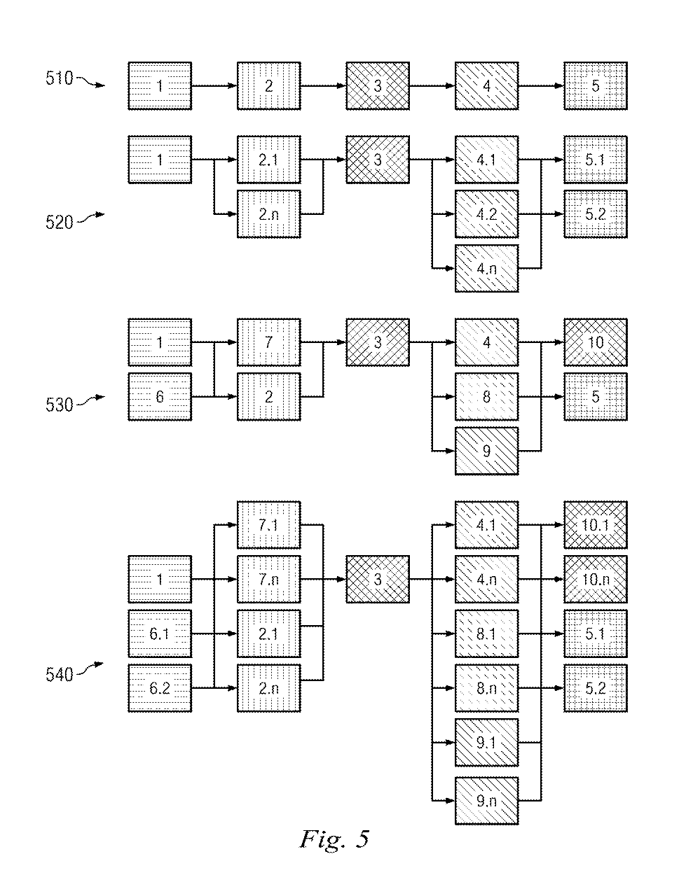

Workout routines may have a broad set of options, as depicted in FIG. 5. Routine 510 includes a fixed sequence of fixed exercises. Routine 520 includes a fixed sequence of level-based exercises. Routine 530 includes a variable sequence of fixed exercises. Routine 540 includes a variable sequence of level-based exercises. Exercises can be mixed and matched as appropriate for any given patient's treatment.

Exercises and curriculum are preferably developed in conjunction with respected, credible, e.g., peer-qualified HCPs in specialties of Orthopedics, Physiatry, Neurosurgery, Occupational Medicine, Pain Management, Chiropractic and Physical therapy. The acumen and expertise of the HCPs may be used to create resources that are directed at treating physical impairments, pain, and/or disorders of the lumbar spine, cervical spine, knee, hip, shoulder, wrist, foot, ankle, and other particular joint or muscle injuries, fibromyalgia, or other conditions.

In some embodiments, each patient progresses through increasing difficulty levels as the patient improves and becomes more capable. Some embodiments also offer patients the ability to skip some exercises if needed due to impairment, lack of time, or improvement of a particular ability, thereby allowing patients some customization of their regimens. Furthermore, in order to keep patients involved, encouraged, and not pushed beyond their physical limits, each body area program preferably lasts no greater than about 35-40 minutes, though different lengths are possible in other embodiments.

There are options for physical therapy with and without equipment. Examples of equipment include, but are not limited to, resistance bands, body bands, Yoga mats, Yoga blocks, inflatable exercise balls, exercise roller wheels, low weight dumbbells/wrist and ankle weights, push up assistive devices, hot packs, cold packs, support garments for lower backs and knees, pain relief gels, recovery drinks, nutritional meals and supplements, weight loss programs, and the like, typically equipment that is present or readily available for home use. The electronic-media-based physical therapy instruction resources offer an opportunity for upsale to other products or other exercise/fitness programs, which is an additional revenue generator for the creator of the resource as well as for other entities that might supply the equipment.

Examples of other materials include, but are not limited to, a Product Guide which will provide information about the product, help elicit and define the end user's motivations and reasons for participation in the product, educate and describe the products therapeutic objectives, instruct the end user in the use of the product and program, and provide an explanation of the product's efficacy. An assessment guide and recommended tests may also be included to determine baseline physical degree of impairment and appropriate level of participation. The assessment guide may be accompanied by an online test collection of results for later analysis and use by HCPs and other entities. Some examples additionally include an assessment of end user objectives and goals through a formatted questionnaire. Other materials may include a program schedule, a nutrition guide, website forums, opportunities to buy or rent equipment, other educational resources, and the like.

The electronic-media-based physical therapy instruction resources can be used on a variety of platforms, including, for example:

DVD players attached to TV sets/Monitors/projectors, playing DVDs
Console devices attached to TV sets/Monitors/projectors, running proprietary discs:

### Wii™

### PlayStation™ 2/3

### Xbox™ (w/ & w/o Kinect™)

PCs attached to TV sets/Monitors, running PC discs
PCs attached to TV sets/Monitors, connected to the internet, running hosted software
Any streamable portable device, including without limitation a cell phone, tablet device, laptop, netbook, etc.
Regarding any streamable device or other internet connected device, the connectivity may be wired, wireless, radio frequency, cellular data, SMS, satellite, or any other type of internet connection available.

Also, there are varying degrees of interaction with the user. DVD systems are generally not very interactive, whereas computer-based systems and game console-based systems are generally more interactive. Platforms with such interactive intelligence, including web-based platforms with real-time or periodic human input, query the patient, adjust the workouts accordingly, interact on an individual basis, and record performance, amongst other capabilities. Platforms with interactive feedback monitor the patient in real-time, giving constant feedback on how well the patient is performing the exercise routines. The scope of embodiments includes multiple products with different levels of interaction, where examples of the products include, but are not limited to:

DVDs for DVD players (or Blu-ray discs for Blu-ray players)
Console discs for proprietary platforms

### Wii™

### PlayStation™ 2/3

### Xbox™ (w/ & w/o Kinect™)

Discs for computer-based platforms
Hosted software streamed or downloaded to the patient
Various embodiments include one or more advantages over conventional physical therapy. In one aspect, the electronic-media-based physical therapy instruction resources preferably: 1) increase compliance with a medically recommended or prescribed treatment plan and 2) decrease the recidivism of functional impairment and pain and 3) decrease the requirement for additional healthcare utilization through a sustainable maintenance program.

Furthermore, some embodiments provide comparatively lower cost option compared to present physical therapy options, optimal and flexible scheduling for participation as time of day is entirely end user determined, and elimination of the need for transportation to/from a physical therapy center. Moreover, the ability to use the physical therapy instruction resources in the home provides an enjoyable and convenient environment that users are able to utilize daily without an associated per visit/treatment cost that is typically associated with traditional physical therapy programs.

In various embodiments, there is a creating party behind the physical therapy instruction resources. An example is a person or company designing, programming, and/or distributing the physical therapy resources. In one other embodiment, the creating party designs, programs, and distributes one or more physical therapy resource(s). In this example, however, the creating party is the originator of the resources and provides the resources to a HCP, a HIC, a government or private employer, or directly to the end-user or through a third party such as a pharmacy. An originating party may also include a person or company who purchases the rights to distribute the resources from a creating party.

Further in this example, the originating party acts a resource, either directly to the patient, or through a third party, such as a HCP, an HIC, or an employer. For instance, the originating party may have a website and/or phone line set up to assist patients and/or third parties and to generally facilitate the provision and use of the resources.

For instance, the originating party may have network resources that track progress of individual patients and then report on the progress to the patients themselves and/or to employers, HCPs, HICs. In fact, in some instances, the originating party may act as a resource to both the patient (by providing the resources) and the employer/HCP/HIC by reporting on progress and status. In some instances, the electronic resources that the patient uses manually or automatically report on the patient's progress. The employer/HCP/HIC then uses a web portal or other electronic resource to receive the reporting. The originating party may also act as a reference for education for patients and prospective patients through, for example, a web portal or other media. Education may focus on physical therapy generally, one or more specific body parts, pain, success, etc.

Some embodiments also include the originating party offering personal interaction to the patients, either in-person or electronically. For instance, an originating party may be affiliated with service providers around the country or around the world. In one example, the originating party has a network of physical therapists available for phone consultations, video consultations, in-person visits, and/or the like. In fact, any type of health service provider, such as a physical therapist, MD, chiropractor, etc., may be affiliated with the originating party to supplement the electronic resources. In some instances, the network of health service providers may be geographically linked so that patients may be referred to local or regional health service providers. Referrals may be made in any manner, including by a web resource of the originating party (e.g., sites to “Find a Physical Therapist in your area,” “Find a Chiropractor in your area,” etc.).

Furthermore, the patient may receive access to the network of health service providers included in a set of services with the electronic resources, a la carte, or in any other manner. The network of health services may provide one or more of any of the following services: one-on-one time with patients, personalized tailoring of regimens, patient follow-up, patient analysis, patient confidence building, patient education, etc. The originating party may receive payment in any of a variety of ways, including directly from a patient and/or through a employer/HCP/HIC.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, system, means, methods and steps described in the specification. As one of ordinary skill in the art will readily appreciate from the disclosure of the present invention, processes, machines, manufacture, systems, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer program product having a computer readable medium tangibly recording computer program logic for providing physical therapy to a patient electronically at home, the computer program product comprising:
code to present instructions for physical activity to the patient via a display, where the physical activity comprises an exercise that is indicated for treatment of a physical limitation;
code to receive data from a user interface device, the data indicating movement of the patient;
code to analyze the data from the user interface device to discern achievement within a physical therapy regimen; and
code to select one or more subsequent exercises for the patient based at least in part on the analyzed data.

2. The computer program product of claim 1 in which the code to present instructions includes code to present the physical therapy regimen to the patient, (a) where the physical therapy regimen focuses on a single regions of the body selected from the list comprising at least back; knee; shoulder; hip; neck; wrist; foot and ankle; joints; muscles; and combinations thereof; (b) where the physical therapy regimen includes one or more workout routines selected from the list consisting of:
a fixed sequence, fixed exercise routine;
a fixed sequence, level-based routine;
a variable sequence, fixed exercise routine; and
a variable sequence, level-based routine; or a combination of (a) and (b).

3. The computer program product of claim 1 in which the code to analyze the data from the user interface device comprises code to assess capabilities of the patient; in which the code to present instructions comprises code to query a patient's reasons for participating in the physical therapy regimen; in which the code to analyze the data from the user interface device comprises code to assess Body Mass Index (BMI) of the patient; in which the code to select subsequent exercise comprises code to allow the patient to skip a particular movement; or a combination thereof.

4. The computer program product of claim 1 (a) in which the code to present instructions comprises code to render an avatar representing at least one of:
a human instructor; and
the patient; (b) in which the code to receive data from the user interface device comprises at least one of
code to receive data from a camera; and
code to receive motion data from a movement detector; or a combination of (a) and (b).

5. The computer program product of claim 1 comprising at least one of
an optical disc readable by a DVD or Blu-ray player;
a computer-readable medium compatible with a gaming console;
a computer readable medium for a general-purpose computer; and
a resource stored on a remote computer-readable medium and sent over a computer network to an electronic device associated with the patient.

6. The computer program product of claim 1 further comprising code to report on progress of the patient electronically to a third party.

7. A computer system for providing a physical therapy resource to a patient at home, the computer system comprising:
a memory storing computer-executable code for providing physical therapy instruction to the patient to treat a physical function limitation;
a processor in communication with the memory and executing the computer-executable code for providing the physical therapy instruction to the patient;
a user interface system providing the physical therapy instruction to the patient as multi-media output and using feedback to measure user participation and progress in treating the physical function limitation, further in which the processor assesses a physical capability of the patient through intelligent feedback with the user and selects one or more subsequent exercises for the patient based at least in part on measured user participation.

8. The computer system of claim 7 comprising at least one of: a DVD or Blu-ray player; a gaming console; and a computer.

9. The computer system of claim 7 in which the user interface system comprises:
a hand-held motion detector that reports patient movement to the processor; and
a feedback loop in which the processor receives data from the hand-held motion detector, processes the data, and generates information for the multi-media output based at least in part on the processed data.

10. The computer system of claim 7 in which the user interface system comprises:
a camera that reports patient movement to the processor; and
a feedback loop in which the processor receives data from the camera, processes the data, and generates information for the multi-media output based at least in part on the processed data.

11. The computer system of claim 7 in which the user interface system includes a monitor or television screen that presents an image of a human physical therapist that instructs the patient to perform physical activities; in which the user interface system includes a monitor or television screen that presents an avatar representing a physical therapist that instructs the patient to perform physical activities; or a combination thereof.

12. The computer system of claim 7 comprising a smartphone that executes a physical therapy application; a computer that receives the computer-executable code over the Internet; or both.

13. The computer system of claim 7 in which the user interface system provides feedback to the patient to apprise the patient of the patient's progress.

14. A process for providing a physical therapy resource to a patient in which the patient is remote from a physical therapy clinic, the process comprising:
providing a feedback loop between a processor-based device that analyzes patient achievement with a physical therapy regimen and a user-interface device that provides signals indicative of a patient's motion;
presenting instructions for physical activity to the patient via a display, where the physical activity comprises an exercise that is indicated for treatment of a physical limitation, the exercise being part of the physical therapy regimen;
analyzing the signals from the user interface device to measure patient achievement within the physical therapy regimen; and
selecting one or more subsequent exercises for the patient based at least in part on the measured patient achievement.

15. The process of claim 14 in which the processor-based device provides feedback to the patient via the display to apprise the patient of the patient's progress.

16. The process of claim 14 in which presenting instructions includes presenting the physical therapy regimen to the patient, (a) where the physical therapy regimen focuses on a single regions of the body selected from the list comprising at least back; knee; shoulder; hip; neck; wrist; foot and ankle; joints; muscles; and combinations thereof; (b) where the physical therapy regimen includes one or more workout routines selected from the list consisting of: a fixed sequence, fixed exercise routine;
a fixed sequence, level-based routine;
a variable sequence, fixed exercise routine; and
a variable sequence, level-based routine; or a combination of (a) and (b).

17. The process of claim 14 in which analyzing the signal from the user interface device comprises assessing capabilities of the patient; in which presenting instructions comprises querying a patient's reasons for participating in the physical therapy regimen; in which analyzing the signals from the user interface device comprises assessing Body Mass Index (BMI) of the patient; further in which selecting subsequent exercise comprises allowing the patient to skip a particular movement; or a combination thereof.

18. The process of claim 14 further comprising:
reporting on progress of the patient electronically to a third party.

19. The process of claim 14 in which the display presents an image of a human physical therapist that instructs the patient to perform the physical activity; in which the display presents an avatar representing a physical therapist that instructs the patient to perform the physical activity; or a combination thereof.

20. The process of claim 14 in which the processor-based device receives data from the user interface device, processes the data, and generates information for the display based at least in part on the processed data.
